(19) United States
(12) Patent Application Publication
(10) Pub. No.: US 2013/0238352 A1
(43) Pub. Date: Sep. 12, 2013

(54) Stream-lined system for electronically recording doctor-written prescriptions coupled with paper and electronic viewing methods, tailored for retail pharmacy operations

(71) Applicants: James Mitchell Tussey, Caro, MI (US); Mark Alan Wicks, Flushing, MI (US)

(72) Inventors: James Mitchell Tussey, Caro, MI (US); Mark Alan Wicks, Flushing, MI (US)

(21) Appl. No.: 13/815,527

(22) Filed: Mar. 8, 2013

Related U.S. Application Data
(60) Provisional application No. 61/609,292, filed on Mar. 10, 2012.

(51) Int. Cl. G06F 19/00

(52) U.S. Cl. CPC G06F 19/3456
USPC 705/2

(57) ABSTRACT

A pharmacy process for effecting the capture and storage of an electronic image of a paper-prescription written by a doctor that minimizes human effort, cost, and occupied space while filling the prescription. Use is made of only one computer-with-memory-and-a-computer-program, one computer-controllable specialized-scanner, one strip-printer, at least one computer-controlled conventional-printer to print peel-off labels or a Clinical Label, and such number of simple terminals as are needed for the workload of the pharmacy. Each simple terminal has a monitor, keyboard, and bar-code scanner. Whether a first filling or a refilling, the critical and necessary procedure of a Pharmacist's review-verification of the filled vials (and their labels) being in full compliance with the prescribing doctor's requirements is facilitated by providing a legible-image of the original prescription on a monitor even if the prescription's paper is copy-resistant.

### RELATED APPLICATION

This application claims the benefit of, and priority from, U.S. Provisional Patent Application No. 61/609,292 filed Mar. 10, 2012, the disclosure of which is hereby incorporated herein in its entirety.

### BACKGROUND

Retail pharmacies need to be certain that the correct medicine in the correct strength coupled with the correct frequency of administration, and that the correct total amount is distributed to a client that was prescribed by the client's doctor (or other prescriber), while minimizing the total cost to the pharmacy of processing the prescription. It is also necessary to have the medicine include instructions for the administration of the medicine and desirable to include information about the nature of the medicine. Strength of medication is the amount of medication in a single pill or dose such as 100 mg per pill. Frequency of administration is how often medication is to be administered to the client, such as twice a day. Dosage is the number of pills or doses to be taken by a client at one time, such as two pills with breakfast and one pill at bedtime. The present invention includes machines and methods of using computer controlled machines to accomplish the need while decreasing initial cost, area occupied, and labor cost.

Herein the prescriber of medicine is called a doctor. It is well known that members of several licensed professions may prescribe medications and they are herein subsumed under the title “doctor.”

A component of the cost saving aspect of the present invention involves effecting the efficient use of persons with low-skills, of un-licensed persons with moderate skills (such as certified pharmacy technicians in States where such persons are not licensed), and of licensed individuals (such as pharmacists) where appropriate.

The critical function in the processing of a prescription is satisfying the requirement that a human, licensed pharmacist verify that what is in the medicine container (vial) corresponds to what is specified within the doctor's prescription (including dosage instructions that accompany the vial) prior to transferring the vial to a client. This necessary and required function is routinely complicated by the need to read and understand what a doctor has written on the prescription. The present invention includes facilitating this requirement.

Procedures, methods, systems and machines exist (which are mostly appropriate for mail-order pharmacies or hospitals or the like) for the processing of a prescription that use machines or robots to place medication into vials or the like. While the use of such machines or robots is not precluded by the present invention, the present invention does not anticipate the use of such automated machines.

### DEFINITIONS & COMPONENTS

In the art of processing prescriptions the terms “filling” or forms of “to fill” are commonly used. Since it appears that such a term of art encompasses a variety of activities, it will be used sparingly. When used, such a term of art shall be interpreted to include conventional processes well understood by one skilled in the art.

The word “vial” is used herein, and in the claims, to indicate a container for receiving medication and may include bottles, blister-packs, syringes or another container that is appropriate to the medication involved.

Computer: It is sufficient to have only one computer 10 that communicates with: one specialized-page-scanner 20; strip-printer 30; at least one terminal 40 comprising a monitor 46, keyboard 42, bar-code-scanner 44, and optionally a mouse; and with a conventional-printer 50. In most pharmacies, a plurality of terminals will communicate with the computer. A preferred terminal with sufficient capability may be selected from very low power, no-operating-system terminals made by Axel Technologies

A specialized-page-scanner 20 is used by the present invention. The specialized page-scanner is capable of receiving an image that is on a piece of paper (or the like) and converting the image into an electronic form that is capable of being seen by a human using a computer/computer-program and monitor. The electronic form is not only capable of being seen on a monitor, but the electronic form is also capable of being reproduced onto a piece of paper. Preferably, the specialized page-scanner scans both sides of the scanned piece of paper. The specialized page-scanner contemplated by the present invention is effectively connected to (and communicates with) a computer 10, is able to scan both sides of a piece of paper, and is able to have its parameters adjusted by a computer-program 12 that is within the attached computer. The preferred specialized page-scanner is a Fujitsu FI-6130. The computer-program 12 is able to craft a legible-image of the prescription even if the prescription is written on copy-resistant or counterfeit-resistant paper.

Strip-printer 30: The preferred thermal strip-printer 30 that is used to print a “thermal receipt” is the same sort of thermal strip printer commonly used to print receipts or credit card information. The preferred strip-printer communicates with and is controlled by the computer. The preferred strip-printer is an Epson TM-T88V.

Conventional-printer 50: A conventional printer, preferably of “laser” type, is available for selectively printing on specialized paper one or more of the following:
to print standard labels to be used with the vials and a description of the medication;
to print standard labels to be used with record keeping and patient communication;
or to print a “Clinical Label™” 100 that contains information specific to the pharmacist's review and approval process in an easy-processing tab form that folds and fits under the standard labels.

The Clinical Label 100 also contains information that a pharmacist should consider such as an image of the original doctor-written prescription, clinical guidelines, patient information, previous medications dispensed to the client, and drug interaction information. The option to provide a Clinical Label is a feature of the present invention. The conventional-printer communicates with and is controlled by the computer, and is preferably capable of color printing. Details are provided below.

### FIGURES

FIG. 1 shows the major items used by the invention and indicates their communication interconnections. Each line on FIG. 1 may be a bi-directional communication link.

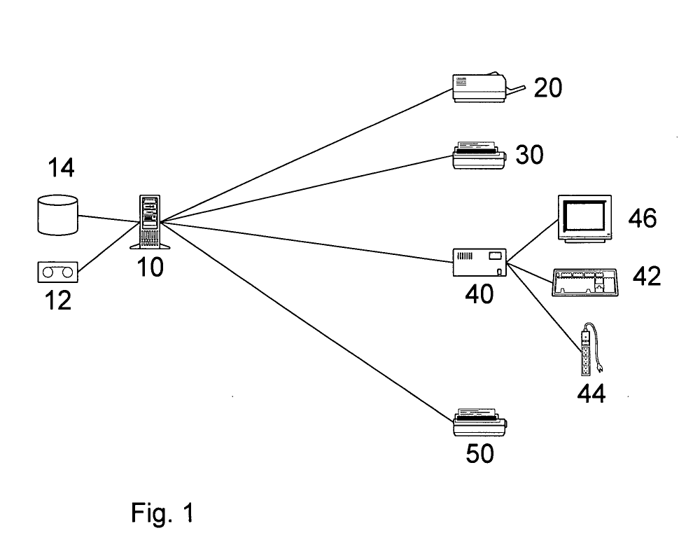

FIG. 2 shows an example of the Clinical Label.

### CONCISE DESCRIPTION OF THE PREFERRED IMPLEMENTATION OF THE PRESENT INVENTION

In the preferred embodiment of the present invention directed to the filling of a prescription for a previous patient/client, the process at a pharmacy comprises:

1. A prescription for one or more medicines is presented to, and received by, an individual at the pharmacy in paper form. Receipt of a paper prescription by the use of a facsimile-machine is contemplated. (Alternate embodiments include receiving a prescription by electronic means.) This step requires little skill.
2. However the prescription is received, the paper prescription is imported by a human into the specialized-page-scanner 20 that is controlled by a computer 10 and computer-program 12. An essential aspect of the present invention is that the only human act at this stage is the importation of the paper prescription into the specialized page-scanner's orifice-for-receiving-a-document and then retrieving the paper prescription after it has been scanned. The controlling computer program does not interact with the human who imports a paper prescription into the one specialized page-scanner. The controlling computer program senses when a document is imported into the specialized page-scanner. The specialized page-scanner is controlled by a unique computer program so as to effect a computer record in a database that is the image in electronic form of the scanned prescription that is legible in spite of the inevitable wide variation in the appearance of, and dimensions of, paper prescriptions. Preferably, both sides of the paper prescription are scanned. This step requires little skill as it involves little more than importing a paper prescription into the specialized page-scanner.

It is a significant aspect of the present invention that only one specialized page-scanner is needed per pharmacy with an attendant saving in initial cost, training, electricity, and occupied space. Furthermore, this step may proceed independently of the following steps and may be effected by persons of little skill as time is available from their other duties resulting in efficient use of their time.

3. The image obtained from the aforementioned computer record in a database resulting from using the computer controlled specialized-page-scanner 20 is caused by the computer-program 12 to be printed by a strip-printer 30r under computer control. Under computer control, along with a legible copy of the paper prescription is also printed a bar-code that uniquely identifies the paper prescription. The printed bar-code is readable by a conventional bar-code-scanner 44, and 115 preferably includes a human readable alpha-numeric equivalent to the printed bar-code. Preferably, pharmacy identification is also printed. Preferably, the strip-printer is a thermal type as customarily used to print receipts. The resulting paper strip printed by the strip-printer is called the “thermal-receipt” and minimally it shows a copy of the paper prescription and a unique bar-code on one piece of paper. This step requires no human participation beyond moving the thermal-receipt to the next step.
4. Preferably, a visual comparison is made between the paper prescription and the content of the thermal-receipt. Because of the computer program's interaction with the specialized page-scanner to effect a legible electronic image of the paper prescription, discrepancies are expected to be very rare and due to a defect with the strip-printer. The latter is expected most often to be due to the strip-printer exhausting its supply of paper and thus requiring a re-scan after providing a fresh spool of paper to the strip-printer. The two documents (the paper prescription and the thermal-receipt) are placed into a simple basket that will eventually be used to receive one or more vials containing medicine. This step requires little skill.
5. The basket is moved to a computer controlled terminal 40 comprising at least a monitor 46, a keyboard 42, and a bar-code-scanner 44. At this step, supplemental information is caused to augment the computer record associated with the prescription. Supplemental information includes the name of the client, name of prescribing doctor, name of the medication and its strength, instructions for administration of the medication, renewal/refill information, and the like. A skilled person enters into the computer (using the keyboard) supplemental information from either the paper prescription or from the prescription seen on the thermal-receipt and automatically causes the computer to associate that information with the prescription's electronic image record by scanning the bar-code on the thermal-receipt. Computer programming allows the flexibility to allow bar-code scanning that may precede or follow the entry of information using the keyboard. Thus, an alternative is for the skilled person to start this step by scanning the bar-code on the thermal-receipt and that scanning will automatically cause the computer program to place the image of the scanned prescription on the monitor such that it can be seen. With the image of the scanned prescription on the monitor, the skilled person may use the keyboard to enter associated supplemental information. With either sequence, after the bar-code on the thermal-receipt is scanned by a bar-code scanner and the supplemental information has been imported into the computer, verification of the completion of the task is facilitated by displaying an electronic copy of the prescription on the monitor along with the information.

Some of the useful information may be retrieved automatically from preexisting records in the computer's memory 14. Such items may be information about the prescribing doctor, details about the client (including DOB, gender, address, telephone number, and E-mail address) and possible medication reactions and interactions.

6. Once the operator of the terminal is satisfied that desired and needed information has been entered and is visible on the monitor, and has verified that the image of the prescription is reasonably legible, the operator of the terminal selectively causes the conventional-printer 50 to print at least one of the following:
peel-off labels, and a description of the prescription and of the medication onto a standard dual-bond 8.5 by 11 inch paper form; or
peel-off labels, a description of the prescription and of the medication, and a facsimile of the scanned prescription onto a Clinical Label 100 dual-bond 8.5 by 14 inch paper form. The Clinical Label also contains information that a pharmacist should consider, as mentioned previously, such as dosage guidelines, previous medications dispensed to the client, allergies, drug interaction information, and billing information. The option to provide a Clinical Label is a feature of the present invention—details of the Clinical Label are provided in a separate section below.
   7. The basket proceeds to an area where the prescribed medication is placed in a vial labeled using one or more of the peel-off labels printed on dual-bond paper by the conventional-printer. This step could be called the filling step. However, as previously stated, this task is performed as desired by individual pharmacists or pharmacies with wide variations. However performed, at the end of this step medications are contained within a vial (or vials) and the vials are labeled.
   8. Without fail, prior to dispensing the medication to the client, a licensed pharmacist shall verify that the vials are ready for distribution to the client by looking into each vial, by estimating the content of each vial, and checking the label on each vial including that the label has the prescribing doctor's intended instructions. The present invention facilitates this necessary and critical step by allowing the pharmacist to call up on a monitor all of the information in the computer about the prescription and most distinctly the pharmacist is able to see a copy of the actual prescription on the monitor. As part of the verification, the pharmacist also considers other pertinent information available to the pharmacist such as known patient history, known patient medications, the drug's indications for use, and its contraindications. As an alternative to using information called up on a monitor, a pharmacist may use the conventionally-printed Clinical Label document that contains the required information including a facsimile of the original prescription

The user of the process may select when the paper prescription is sent to a permanent file as the thermal-receipt and the computer accessible image of the paper prescription and optionally the Clinical Label contain the information needed for filling and for the critical verification step. Some users will decide to send the paper prescription to a permanent file late in the process. When a prescription is to be refilled, another value of the present invention becomes apparent. No need exists to retrieve the original paper prescription at refill time because an image of the paper 185 prescription is readily available. Of course, for auditing purposes, or the like, the original paper prescription is still available.

### Concise Description of a Supplemental Implementation of the Present Invention:

The utility of the present invention is especially apparent when a prescription that was processed according to the preferred implementation of the present invention, is to be refilled.

In the supplemental embodiment of the present invention, the process at a pharmacy comprises:

1. A request is received for a refill of some or all of the medications prescribed within a prescription that has been processed according to the preferred embodiment. The request is accompanied by identification information such as the name of the client, identifying numbers or a bar-code on the medication's label, or the like.
2. Identifying information is entered by a skilled person at a computer controlled terminal comprising at least a monitor, a keyboard, and a bar-code scanner. The computer program causes the display of an image of the original prescription to be seen on the monitor. The skilled person verifies that a refill is justified. When satisfied, the operator selectively causes the conventional-printer to print at least one of the following and places the resultant paper into a basket:
peel-off labels, and a description of the prescription and of the medication onto a standard dual-bond 8.5 by 11 inch paper form; or
peel-off labels, a description of the prescription and of the medication, and a facsimile of the scanned prescription onto a Clinical Label dual-bond 8.5 by 14 inch paper form. The Clinical Label also contains information that a pharmacist should consider such as dosage guidelines, previous medications dispensed to the client, and drug interaction information. The option to provide a Clinical Label, that contains information specific to the pharmacist review and approval process in an easy-processing tab form that folds and fits under the standard labels, is a feature of the present invention.
   3. The basket proceeds to an area where the prescribed medication is placed in a vial labeled using one or more of the peel-off labels printed on dual-bond paper by the conventional-printer. This step could be called the filling step. However, as previously stated, this task is performed as desired by individual pharmacists or pharmacies with wide variations. However performed, at the end of this step medications are contained within a vial (or vials) and the vials are labeled.
   4. Without fail, prior to dispensing the medication to the client, a licensed pharmacist shall verify that the vials are ready for distribution to the client by looking into each vial, by estimating the content of each vial, and checking the label on each vial including that the label has the prescribing doctor's intended instructions. The present invention facilitates this necessary and critical step by allowing the pharmacist to call up on a monitor all of the information in the computer about the prescription and most distinctly the pharmacist is able to see a copy of the actual prescription on the monitor. As an alternative to using information called up on a monitor, a pharmacist may use the printed document that contains the required information including a facsimile of the original prescription (the Clinical Label).

### Concise Description of an Additional Implementation of the Present Invention:

The utility of the present invention is additionally apparent when processing a prescription from a new client.

In the additional embodiment of the present invention, the process at a pharmacy comprises: receiving the paper-prescription;

importing the paper-prescription into the computer-controllable specialized-scanner automatically to communicate a scanned image of the paper-prescription to the computer;
causing without human intervention the computer-with-memory-and-a-computer-program to manipulate said scanned image of the paper-prescription so as to effect a legible-image of the paper-prescription if displayed on a human readable device and to do so even if the prescription's paper is copy-resistant;
causing without human intervention the computer-with-memory-and-a-computer-program to associate a unique number with said legible-image of the paper-prescription and store both in the computer memory, and do so such that they may be retrieved;
causing without human intervention the computer-with-memory-and-a-computer-program to have the strip-printer print as paper thermal-image of said legible-image of the paper-prescription along with said unique-number in the form of a bar code;
moving the paper-prescription and said paper thermal-image to a computer-controlled terminal;
using the computer-controlled terminal and the client's name, inherently found on both the paper-prescription and on said paper thermal-image, an operator searches computer-memory for a previously stored patient-record and, when no patient-record is found for the new patient, the operator causes an empty patient-screen to appear into which is typed required information about the new patient;
using the computer-controlled terminal, the operator causes an empty fill-screen that is linked with the just created patient-record to appear on the terminal's monitor into which the operator types, using the terminal's keyboard, needed information about the medication found on the paper-prescription and on said paper thermal-receipt, and effects a link to said stored legible-image by using the terminal's bar-code scanner to scan said bar code on said thermal-receipt, which also causes said legible-image to be displayed on the terminal's monitor;
instructing the computer-controlled conventional-printer to print peel-off labels minimally containing information complying with requirements for labeling medication, instructions for the use of prescribed medication contained on the prescription, and to print such additional information as is desired when the operator is satisfied that the needed information has been entered into said fill-screen and has verified that said legible-image is legible—preferably a Clinical Label is printed;
causing by exiting said fill-screen the computer-with-memory-and-a-computer-program to place the new patient-record into memory indexed by patient name and to place into memory a prescription-record that contains pertinent information about the prescription that is such that it can be retrieved should a refill be requested in the future;
filling at least one vial with medication specified by said printed peel-off labels and attaching said printed peel-off labels to filled vials; and
providing to a licensed pharmacist the identical content of said legible-image of the prescription or said thermal-receipt or the paper-prescription to use when verifying that the contents of the vials, their labels, and instructions for their use, are as requested.

### Clinical Label:

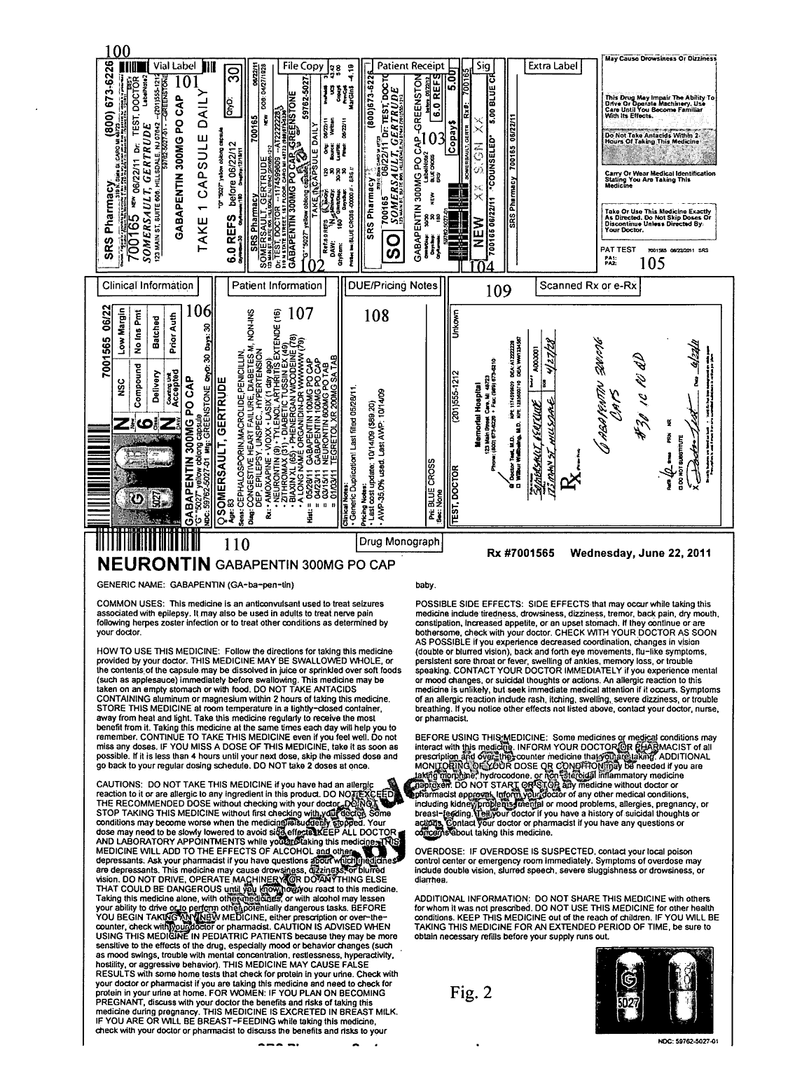

An example of a Clinical Label 100 is seen in FIG. 2. The ability to print, using the conventional-printer 50, comprehensive details on the Clinical Label 100 is a feature of the present invention. Of special note is item 109. Details about each item, numbered to correspond to numbers found on FIG. 2, are listed below and the listing, along with FIG. 2, comprises a description of the Clinical Label wherever used herein including in the claims.

101 Vial Label—Label placed on prescription container that is given to the patient. Complies with legal requirements and other standards for the labeling of retail prescription medication.
102 File copy—Label typically placed on rear of original paper copy of prescription, which is kept on file in the pharmacy. It contains information about Patient, Doctor, Drug, and financial information.
103 Patient Receipt—Given to patient at the time of checkout or delivery of medication. Includes Patient Name, Address, Medication, remaining refills, primary and/or secondary insurance carrier(s), and any charges to the patient.
104 Manual Signature Label—Record of delivery of the medication to the patient or patient caregiver. Signed by person picking up prescription as documentation that prescription was picked up by patient or patient's caregiver. Required by third party payers. Used when pharmacy does not have electronic signature capabilities.
105 Medication Auxiliary Labels—Medication precautions specific to medication dispensed. Provided by Medispan Data. Pharmacist's uses his/her discretion on what to place on the patient's prescription vial.
106 Clinical Information—A summary of key information about the fill to help pharmacists in their final review. Along with a summary, physical description, and photo of the drug dispensed, it includes information such as the DEA schedule/class of the drug, whether the patient has had this drug before, whether the doctor allows generic substitution.
107 Patient Medication History—A summary of relevant data about the patient that a pharmacist might use in a final review of the prescription. It contains the patient's name and age, a list of known patient allergies, known diagnoses, and a summary of previous medications taken by that patient.
108 Drug Utilization Evaluation (DUE) and Pricing Notes—A drug utilization evaluation presents a systematic and structured review of criteria to assist the pharmacist in identifying and resolving problems before the patient receives the medication. It includes a review of factors such as drug dosage, under or over utilization of the medication, duplication of therapy with other prescriptions, drug-disease contraindications, drug-drug interactions, and drug-patient precautions (due, for example, to age, gender, pregnancy, prior adverse reactions, or allergies). The pricing notes contain business data helpful for the pharmacist to understand the relationship between the acquisition cost of the medication and the total reimbursed.
109 Scanned Rx or e-Rx—A hardcopy of the legible image of scanned prescription (if received on paper), or a summary of electronic data (if received electronically). This image is available to the Pharmacist on the original fill and all subsequent refills of the medication. This is a valuable check to ensure accuracy in dispensing medications.
110 Drug Monograph or Patient Education Leaflet (PEL)—Reprint of Medispan Data. A required piece to educate the patient in the proper use of the medication. It may include common uses of the medication, proper use, cautions, contraindications, side effects, overdose precautions.

### SUMMARY

One of average skill in the art of the present invention will discern the savings inherent in the practice of the present invention while preserving, and enhancing, the critical role of the attending pharmacist in insuring the delivery of what was intended by the prescribing doctor. Savings are implemented by the practice of the present invention by:
Requiring only one specialized-page-scanner 20 and associated strip-printer 30 thus saving the cost of multiple such and, perhaps more importantly in a crowded pharmacy, saving space. Conventional systems need page-scanners at each work station, while the terminal of the present invention (and its relatively small bar-code scanner) is all that is needed at a work station.
Requiring only one terminal initially. As need/volume grows, additional terminals may be added.
Utilizing persons of little skill to perform the initial processing of paper prescriptions by importation of the paper prescription into the specialized page-scanner's orifice-for-receiving-a-document and then retrieving the paper prescription after it has been scanned. Further savings are effected because this step may be performed asynchronously with the person's other tasks and concurrently while data-entry stations are in use.
Utilizing efficiently persons of skill to import information using a keyboard and the rapid scanning of a bar-code and then to have the computer and computer program do the associating and control of the conventional printer that prints labels and information.
Providing the pharmacist with easy-to-access information for a final review of the vials using the Clinical Label form, or using the on-monitor viewing method, to see a scanned image of the original paper prescription.
Removing the need to retrieve paper copies of a prescription when performing a renewal.

In contrast to existing systems and existing processes for the processing of a prescription, the present invention includes the advantages of:
Requiring no effort on the part of the operator of the specialized page-scanner to cause the electronic image of the paper prescription to be legible as the computer program interacts with the specialized page-scanner to effect this desirable, and time saving, feature. Current systems are known to require effort by an operator to initiate the process and further effort to produce legible images.
Eliminating the task of current systems to peel-and-paste identification bar-codes (or the like) onto the paper prescription with attendant savings of time and effort. Most importantly, the elimination of this step by the present invention prevents a source of error from a human attaching the wrong sticker on a paper prescription.

Three implementations of the present invention's process have been disclosed in the specification and in the claims. Alternatives that take advantage of the set of hardware and computer-program to vary the order of the process steps are anticipated by the disclosure.

We claim:

1. A pharmacy process for effecting delivery of a prescribed medication into at least one vial as specified on a paper-prescription for a previous patient that uses a computer-with-memory-and-a-computer-program; one computer-controllable specialized-scanner; one computer-controllable strip-printer; one or more computer-controlled terminals each comprising a monitor, keyboard, and bar-code scanner; a computer-controlled conventional-printer loaded with paper containing peel-off labels; with each computer-controlled device communicating with the computer; and with descriptive information about the previous patient stored in memory as a patient-record, comprising the steps of:
receiving the paper-prescription;
importing the paper-prescription into the computer-controllable specialized-scanner automatically to communicate a scanned image of the paper-prescription to the computer;
causing without human intervention the computer-with-memory-and-a-computer-program to manipulate said scanned image of the paper-prescription so as to effect a legible-image of the paper-prescription if displayed on a human readable device;
causing without human intervention the computer-with-memory-and-a-computer-program to associate a unique number with said legible-image of the paper-prescription and to store both in the computer memory so that they are able to be retrieved;
causing without human intervention the computer-with-memory-and-a-computer-program to have the strip-printer print a paper thermal-image of said legible-image of the paper-prescription along with said unique-number in the form of a bar code;
moving the paper-prescription and said paper thermal-image to a computer-controlled terminal;
using the computer-controlled terminal and the client's name, inherently found on both the paper-prescription and on said paper thermal-image, an operator searches computer-memory for the previously stored patient-record that is then displayed on the terminal's monitor;
using the computer-controlled terminal, the operator causes an empty fill-screen that is linked with the patient-record to appear on the terminal's monitor into which the operator types, using the terminal's keyboard, needed information about the medication found on the paper-prescription and on said paper thermal-receipt, and effects a link to said stored legible-image by using the terminal's bar-code scanner to scan said bar code on said thermal-receipt, which also causes said legible-image to be displayed on the terminal's monitor;
instructing the computer-controlled conventional-printer to print peel-off labels minimally containing information complying with requirements for labeling medication, instructions for the use of prescribed medication contained on the prescription, and to print such additional information as is desired when the operator is satisfied that the needed information has been entered into said fill-screen and has verified that said legible-image is legible;
causing by exiting said fill-screen the computer-with-memory-and-a-computer-program to place a prescription-record in memory that contains pertinent information about the prescription and that is indexed in memory such that it can be retrieved should a refill be requested in the future;
filling at least one vial with medication specified by said printed peel-off labels and attaching said printed peel-off labels to filled vials; and
providing to a licensed pharmacist the identical content of said legible-image of the prescription or said thermal-receipt or the paper-prescription to use when verifying that the contents of the vials, their labels, and instructions for their use, are as requested.

2. A pharmacy process as described in claim 1 wherein said instructing step further includes printing a Clinical Label.

3. A pharmacy process as described in claim 1 wherein said causing without human intervention the computer-with-memory-and-a-computer-program to manipulate said scanned image of the paper-prescription so as to effect a legible-image of the paper-prescription if displayed on a human readable device step further includes effecting a legible-image of the paper-prescription when the paper-prescription is written on copy-resistant paper.

4. A pharmacy process for effecting the refilling of a prescribed medication and its delivery into at least one vial as specified on a paper-prescription for a previous patient that uses a computer-with-memory-and-a-computer-program; one or more computer-controlled terminals each comprising a monitor, keyboard, and bar-code scanner; a computer-controlled conventional-printer loaded with paper containing peel-off labels; with each computer-controlled device communicating with the computer; and with descriptive information about the previous patient stored in memory as a patient-record during the last filling of the prescription and with information about the prescription to be refilled stored in memory as a prescription-record; comprising the steps of:
receiving a request-for-refill that is associated with the prescription;
retrieving from computer-memory the previously stored patient-record and the appropriate prescription-record onto the terminal's monitor;
causing a fill-screen that is linked with the patient-record and to the prescription-record to appear on the terminal's monitor into which the operator types, using the terminal's keyboard, needed information about refilling the prescription
instructing the computer-controlled conventional-printer to print peel-off labels minimally containing information complying with requirements for labeling medication, instructions for the use of prescribed medication contained on the prescription, and to print such additional information as is desired when the operator is satisfied that the needed information has been entered into said fill-screen and has verified that said legible-image is legible;
causing by exiting said fill-screen the computer-with-memory-and-a-computer-program to place a revised prescription-record in memory such that it can be retrieved should an additional refill be requested in the future;
filling at least one vial with specified medication and attaching said printed peel-off labels to filled vials; and
providing to a licensed pharmacist the ability to see on a monitor a legible copy of the original paper-prescription, and its instructions for the use of prescribed medication, for the pharmacist's use when verifying that the contents of the vials and their labels are as requested.

5. A pharmacy process as described in claim 4 wherein said instructing step further includes printing a Clinical Label.

6. A pharmacy process for effecting delivery of a prescribed medication into at least one vial as specified on a paper-prescription for a new patient that uses a computer-with-memory-and-a-computer-program; one computer-controllable specialized-scanner; one computer-controllable strip-printer; one or more computer-controlled terminals each comprising a monitor, keyboard, and bar-code scanner; a computer-controlled conventional-printer loaded with paper containing peel-off labels, and with each computer-controlled device communicating with the computer, comprising the steps of:
receiving the paper-prescription;
importing the paper-prescription into the computer-controllable specialized-scanner automatically to communicate a scanned image of the paper-prescription to the computer;
causing without human intervention the computer-with-memory-and-a-computer-program to manipulate said scanned image of the paper-prescription so as to effect a legible-image of the paper-prescription if displayed on a human readable device;
causing without human intervention the computer-with-memory-and-a-computer-program to associate a unique number with said legible-image of the paper-prescription and store both in the computer memory so that they are able to be retrieved;
causing without human intervention the computer-with-memory-and-a-computer-program to have the strip-printer print as paper thermal-image of said legible-image of the paper-prescription along with said unique-number in the form of a bar code;
moving the paper-prescription and said paper thermal-image to a computer-controlled terminal;
using the computer-controlled terminal and the client's name, inherently found on both the paper-prescription and on said paper thermal-image, an operator searches computer-memory for a previously stored patient-record and, when no patient-record is found for the new patient, the operator causes an empty patient-screen to appear into which is typed required information about the new patient;
using the computer-controlled terminal, the operator causes an empty fill-screen that is linked with the just created patient-record to appear on the terminal's monitor into which the operator types, using the terminal's keyboard, needed information about the medication found on the paper-prescription and on said paper thermal-receipt, and effects a link to said stored legible-image by using the terminal's bar-code scanner to scan said bar code on said thermal-receipt, which also causes said legible-image to be displayed on the terminal's monitor;
instructing the computer-controlled conventional-printer to print peel-off labels minimally containing information complying with requirements for labeling medication, instructions for the use of prescribed medication contained on the prescription, and to print such additional information as is desired when the operator is satisfied that the needed information has been entered into said fill-screen and has verified that said legible-image is legible;
causing by exiting said fill-screen the computer-with-memory-and-a-computer-program to place the new patient-record into memory indexed by patient name and to place into memory a prescription-record that contains pertinent information about the prescription that is such that it can be retrieved should a refill be requested in the future;
filling at least one vial with medication specified by said printed peel-off labels and attaching said printed peel-off labels to filled vials; and
providing to a licensed pharmacist the identical content of said legible-image of the prescription or said thermal-receipt or the paper-prescription to use when verifying that the contents of the vials, their labels, and instructions for their use, are as requested.

7. A pharmacy process as described in claim 6 wherein said instructing step further includes printing a Clinical Label.

8. A pharmacy process as described in claim 6 wherein said causing without human intervention the computer-with-memory-and-a-computer-program to manipulate said scanned image of the paper-prescription so as to effect a legible-image of the paper-prescription if displayed on a human readable device step further includes effecting a legible-image of the paper-prescription when the paper-prescription is written on copy-resistant paper.
